(19) United States
(12) Patent Application Publication
(10) Pub. No.: US 2015/0145505 A1
(43) Pub. Date: May 28, 2015

(54) DETECTION DEVICE

(71) Applicant: DENSO CORPORATION, Kariya-city (JP)

(72) Inventor: Hirotsugu ISHINO, Toyokawa-city (JP)

(21) Appl. No.: 14/479,697

(22) Filed: Sep. 8, 2014

(30) Foreign Application Priority Data
Nov. 22, 2013 (JP) 2013-241677

(51) Int. Cl. G01B 7/14; G01D 5/20

(52) U.S. Cl. CPC G01B 7/14; G01D 5/20
USPC 324/207.13

(57) ABSTRACT

A magnet generates a magnetic field around a position where a detected object passes. The detected object is formed of a nonmagnetic and conductive material. A first core is a magnetic object equipped to the magnet on a detected object side. A coil is wound around a radially outside of the first core. A second core is a magnetic object connected to the first core on the detected object side. An outer diameter of the second core is greater than an outer diameter of the first core.

### CROSS REFERENCE TO RELATED APPLICATION

This application is based on reference Japanese Patent Application No. 2013-241677 filed on Nov. 22, 2013, the disclosure of which is incorporated herein by reference.

### TECHNICAL FIELD

The present disclosure relates to a detection device configured to detect movement of a detected object.

### BACKGROUND

Conventionally, a known detection device may be configured to detect movement of a detected object, which is formed of a nonmagnetic material or a magnetic material, while being noncontact with the detected object.

Patent Document 1 discloses a detection device to detect revolution of a gear, which is a detected object formed of a magnetic material. Specifically, the detection device exerts a magnetic field on a gear through a core, which is equipped to a magnet on a gear side. In the present state, an amount of magnetic flux flowing through the core, when a projected portion of a gear faces the core, is greater than an amount of magnetic flux flowing through the core, when a recessed portion of the gear faces the core. A coil is wound around the outer circumferential periphery of the core. The coil generates an induced electromotive force according to change in the magnetic flux generated by the core. The detection device detects the induced electromotive force thereby to detect the revolution of the gear. In the detection device, the core has a thin end facing the gear. The thin end is to converge the magnetic flux generated by the magnet onto the projected portion of the gear. The thin end is to enable the detection device to detect the revolution of the gear with high accuracy.

(Patent Document 1)

Publication of unexamined patent application No. H8-160059

In a case where a detected object is formed of a nonmagnetic material, a detection device may detect movement of a detected object in a subsequent way. Specifically, the detection device may exert a magnetic field on the detected object through a core, which is equipped to a magnet on a detected object side. The detected object may cause an electromotive force, which generates a magnetic field in a direction to cancel change in the magnetic field, which passes through the detected object. Thus, the detected object may cause an eddy current. The eddy current may cause a magnetic field, which causes change in a magnetic flux flowing through the core. The change in the magnetic flux may cause an induced electromotive in the coil. The detection device may detect the change in the magnetic flux thereby to detect movement of the detected object. The detection device may employ the thin end in the core on the detected object side, as disclosed in Patent Document 1. In this case, in a case where the detected object is formed of a nonmagnetic material, the thin end may reduce the influence exerted on the core and caused by the magnetic field, which is generated by the eddy current in the detected object. Consequently, it may be concerned about reduction in the induced electromotive force, which is generated in the coil.

### SUMMARY

It is an object of the present disclosure to produce a detection device configured to detect movement of a detected object with high accuracy and/or with high gain.

According to an aspect of the present disclosure, a detection device is configured to detect a movement of a detected object, which is formed of a nonmagnetic and conductive material. The detection device comprises a magnet configured to generate a magnetic field around a position where the detected object passes. The detection device further comprises a first core being a magnetic object and equipped to a detected object side of the magnet. The detection device further comprises a coil wound around a radially outside of the first core. The detection device further comprises a second core being a magnetic object and connected to a detected object side of the first core. The second core is greater than an outer diameter of the first core.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a detection device according to a first embodiment of the present disclosure;

FIG. 2 is a perspective view showing an eddy current generating a magnetic field in a detected object;

FIG. 3 is an analysis result of a magnetic field caused by the detection device according to the first embodiment;

FIG. 4 is a sectional view showing a detection device according to a comparative example;

FIG. 5 is an analysis result of a magnetic field caused by the detection device according to the comparative example;

FIG. 6 is a graph showing an output voltage ratio of the detection device according to the first embodiment relative to an output voltage ratio of the detection device according to the comparative example;

FIG. 7 is a sectional view showing a detection device according to a second embodiment of the present disclosure;

FIG. 8 is a sectional view showing a detection device according to a third embodiment of the present disclosure;

FIG. 9 is a sectional view showing a detection device according to a fourth embodiment of the present disclosure; and

FIG. 10 is a sectional view showing a detection device according to a fifth embodiment of the present disclosure.

### DETAILED DESCRIPTION

As follows, embodiments according to the disclosure will be described with reference to drawings.

### First Embodiment

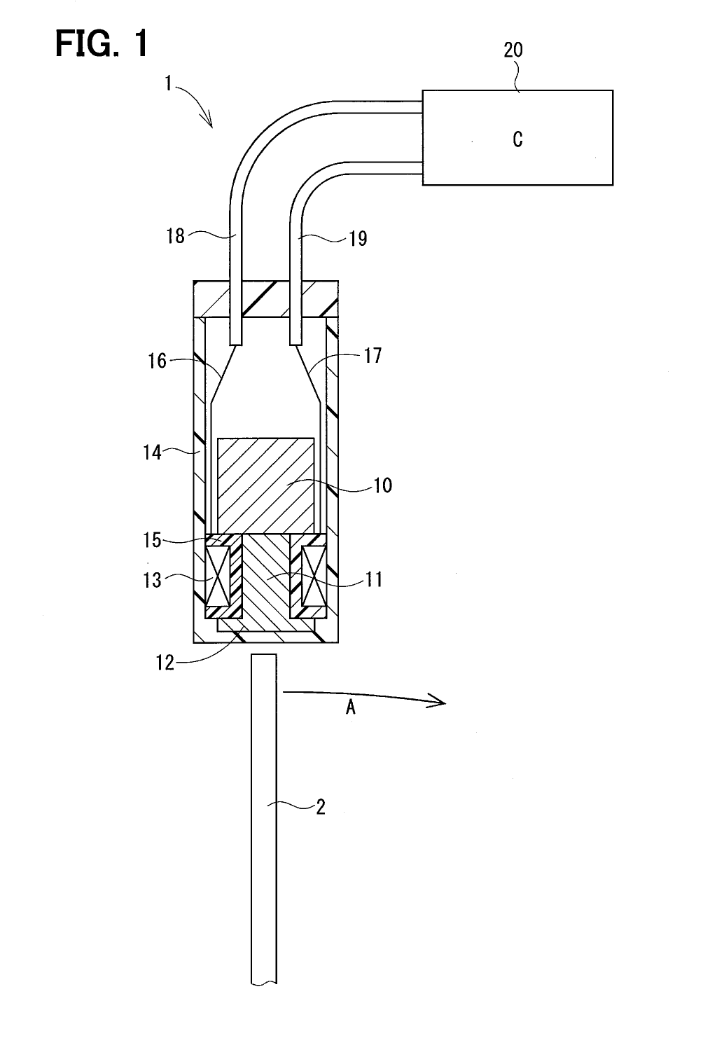

A first embodiment of the present disclosure will be described with reference to FIGS. 1 to 3 and FIG. 6. A detection device 1 according to the first embodiment is configured to detect, for example, a revolution (rotation number) of a turbine blade (blade) 2. The blade 2 is a component of, for example, a turbocharger of an engine. The blade 2 of the present embodiment may be one example of a detected object. The blade 2 may be formed of a nonmagnetic and conductive (electrically conductive) material, such as aluminum and/or titanium, and may be in a thin-plate shape. The blade 2 is rotational in a direction shown by an arrow A in FIG. 1 relative to the detection device 1 while being in noncontact with the detection device 1.

The detection device 1 includes a magnet 10, a first core 11, a second core 12, a coil 13, a case 14, and/or the like. The magnet 10 is magnetized to form an S pole on the side of the blade 2. The magnet 10 is further magnetized to form an N pole on the opposite side of the blade 2. The magnet 10 may be magnetized to form the N pole and the S pole in an opposite form. The magnet 10 forms a static magnetic field at a position, where the blade 2 passes, through the first core 11 and the second core 12.

The first core 11 and the second core 12 are integrally formed of, for example a magnetic material, such as a ferrous material. That is, the first core 11 and the second core 12 are each being a magnetic object. The magnet 10 is located on the opposite side of the first core 11 and the second core 12 from the blade 2. The first core 11 is in a column shape. The first core 11 is connected to the magnet 10 at one end in the axial direction. The first core 11 is further connected to the second core 12 at the other end in the axial direction. The second core 12 is in a disc shape. The first core 11 is located on the opposite side of the second core 12 from the blade 2. The outer diameter of the second core 12 is greater than the outer diameter of the first core 11.

A bobbin 15 is located on the radially outside of the first core 11. The bobbin 15 is formed of an insulative material, such as resin. The coil 13 is wound around the bobbin 15. Two wirings 16 and 17 are taken out of both ends of the coil 13. The wirings 16 and 17 are electrically connected with two wire cables 18 and 19, respectively. The two wire cables 18 and 19 are electrically connected with two terminals (not shown) equipped to a connector 20. The case 14 is formed of a nonmagnetic material such as a metallic material, a resin material, and/or the like. The case 14 accommodates the magnet 10, the first core 11, the second core 12, the coil 13, and/or the like.

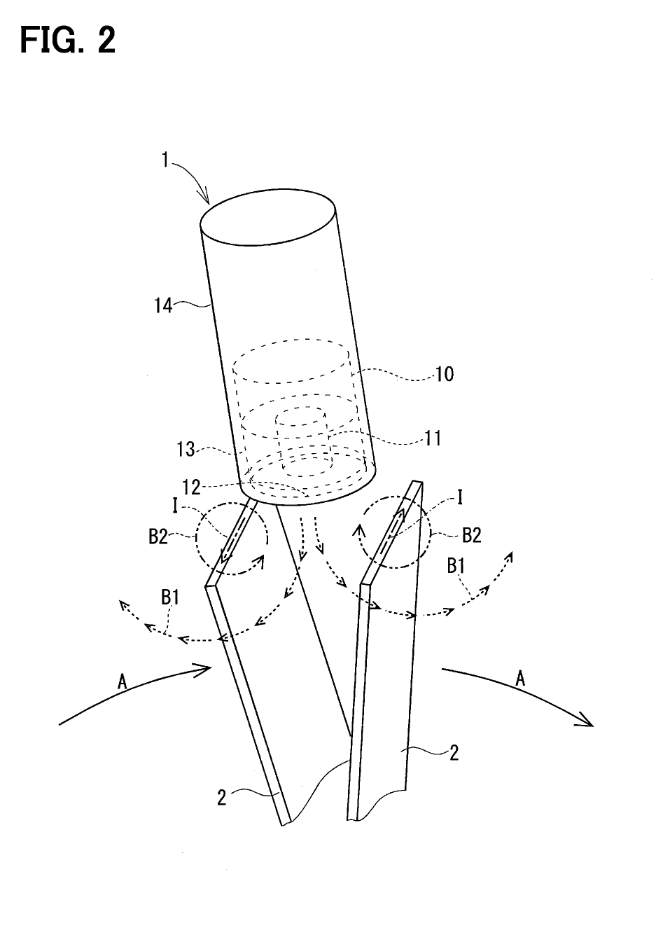

Subsequently, a configuration of the detection device 1 to detect the revolution of the blade 2 will be described. In FIG. 2, chain lines B1 represent a magnetic field, which is generated with the magnet 10. One-point chain lines I represent an eddy current, which flows through the blade 2. Two-point chain lines B2 represent a magnetic field caused by the eddy currents. The blade 2 rotates in a direction shown by an arrow A. When the blade 2 moves in a range of the magnetic field B1 generated with the magnet 10, the blade 2 causes an electromotive force to generate the magnetic field B2 in a direction to cancel change in the magnetic field B1, which passes through the blade 2. Therefore, the blade 2 generates an eddy current I. The eddy current I causes the magnetic field B2, and the magnetic field B2 exerts influence on the magnetic flux, which flows through the second core 12 and the first core 11. Therefore, the magnetic flux, which flows through the second core 12 and the first core 11, changes. In this way, the coil 13 generates an induced electromotive force occurs. Therefore, the present configuration may enable the detection device 1 to detect movement of the blade 2 by detecting a voltage between the terminals, which are connected to the wirings 16 and 17 at both ends of the coil 13.

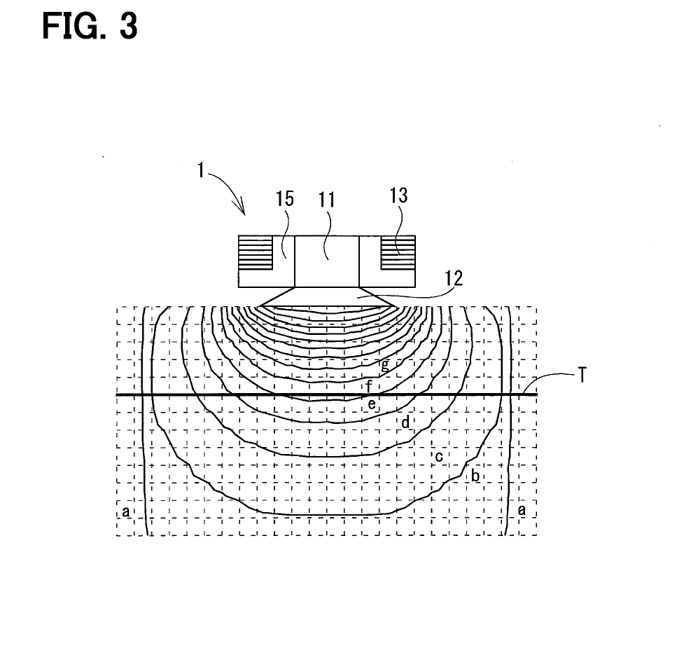

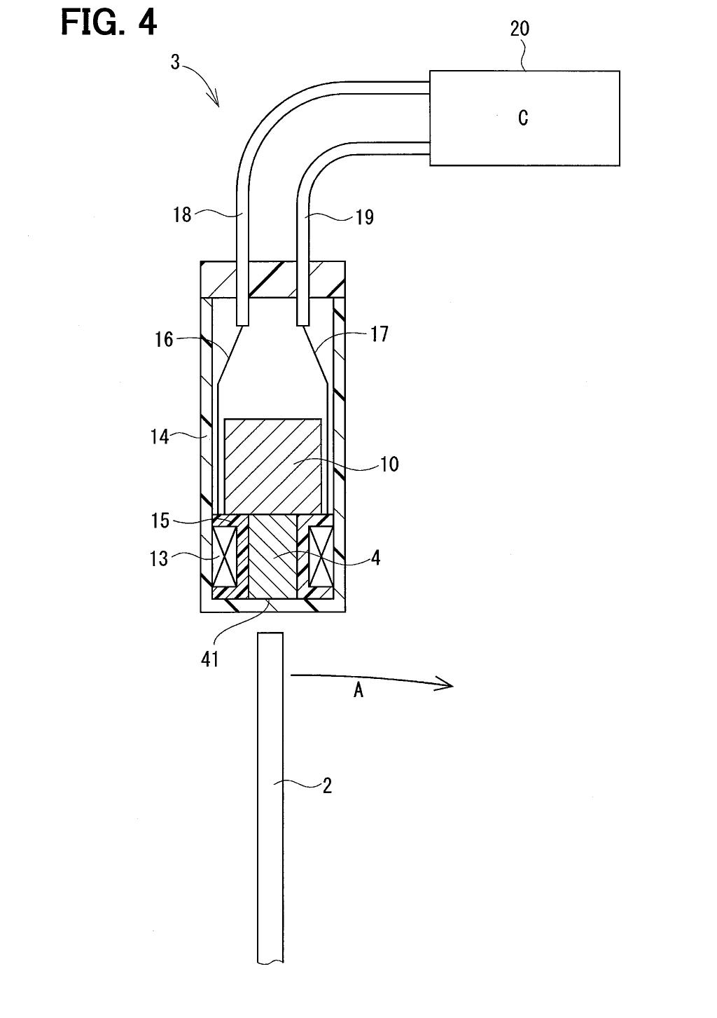

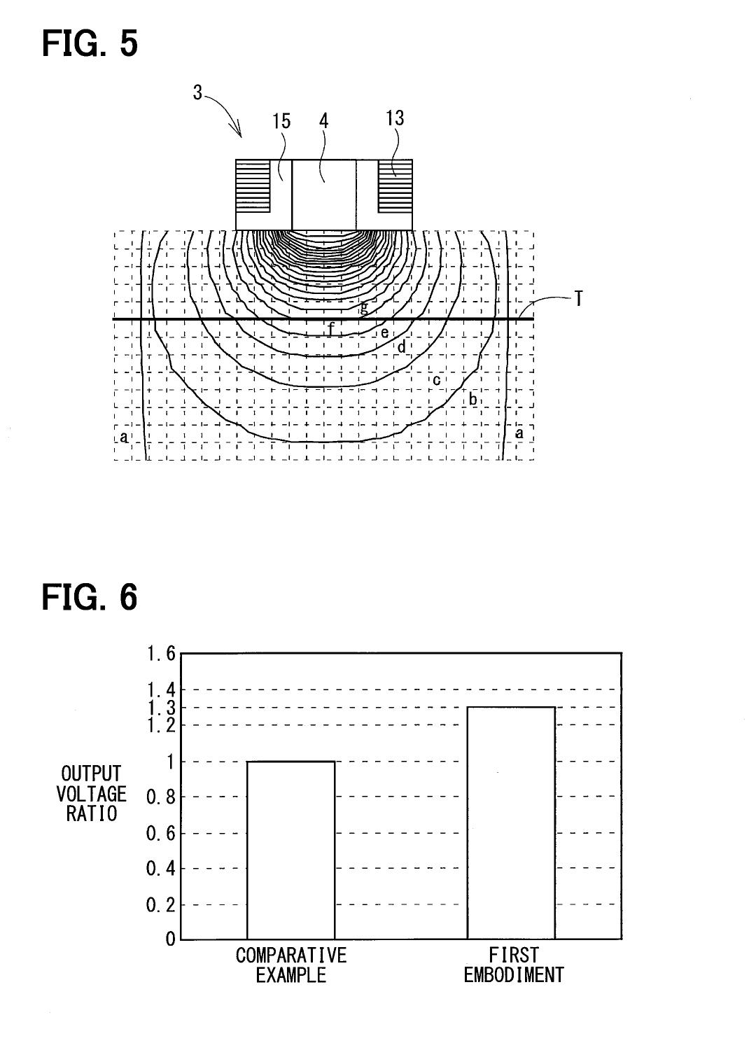

FIG. 4 shows a detection device according to a comparative example. The detection device 3 according to the comparative example is not equipped with the second core 12, which is equipped to the detection device 1 according to the first embodiment. Therefore, the detection device 3 according to the comparative example has a configuration. Specifically, a core 4, which is in a column shape, has an end surface 41 on the opposite side of the magnet. The end surface 41 faces the blade 2. FIG. 5 shows a magnetic field, which is generated from the magnet 10 of the detection device 3 according to the comparative example. In FIG. 5, the magnetic field passes through the core 4. FIG. 3 shows a magnetic field, which is generated from the magnet 10 of the detection device 3 according to the present embodiment. In FIG. 3, the magnetic field passes through the first core 11 and the second core 12. In FIGS. 3 and 5, the notations a, b, c, d, e, f, g represent magnetic fluxes. The magnetic fluxes a, b, c, d, e, f, g are in order of strength of density of the magnetic fluxes from weaker one to stronger one sequentially. In FIGS. 3 and 5, a solid line T represents a position through which an end surface of the blade 2 on the side of the detection device passes.

When comparing ranges of the magnetic fields, which are represented by the strengths c and d of the magnetic flux density at the position represented by the solid line T, the range of the detection device 1 according to the present embodiment is wider than the range of the detection device 3 according to the comparative example. In addition, an area of the second core 12 according to the present embodiment, which is opposed to the blade 2, is wider than an area of the core 4 according to the comparative example, which is opposed to the blade 2. That is, the second core 12 according to the present embodiment is opposed to the blade 2 at a wider area than the core 4 according to the comparative example. Therefore, the core 4 according to the comparative example is apt to be exerted with the magnetic field caused by the eddy current generated in the blade 2, compared with the second core 12 according to the present embodiment. Consequently, change in the magnetic flux generated by the first core 11 according to the present embodiment is greater than change in the magnetic flux generated by the core 4 according o the comparative example.

FIG. 6 shows an experimental result representing a comparison between an output voltage of the detection device 3 according to the comparative example, when detecting movement of the blade 2, and an output voltage of the detection device 1 according to the present embodiment, when detecting movement of the blade 2. The experimental result reveals that the output voltage of the detection device 1 according to the present embodiment, when detecting movement of the blade 2, becomes 1.3 relative to the output voltage of the detection device 3 according to the comparative example, when detecting movement of the blade 2, being 1. That is, when detecting movement of the blade 2, the output voltage of the detection device 1 according to the present embodiment is 1.3 times as magnitude as the output voltage of the detection device 3 according to the comparative example.

The detection device 1 according to the present embodiment may produce operation effects as follows.

(1) The detection device 1 according to the present embodiment includes the second core 12. The second core 12 is on the blade side of the first core 11, around which the coil 13 is wound. That is, the second core 12 is on the side of the first core 11, which is directed to the blade 2. The outer diameter of the second core 12 is greater than the outer diameter of the first core 11. According to the present configuration, the second core 12 may enable to enlarge the range of the magnetic field B1, which is caused by the magnet 10 and applied on the blade 2. Furthermore, the magnetic field B2, which is caused by the eddy current I generated in the blade 2, may enable the second core 12 to exert a large influence on the first core 11. Therefore, the present configuration may enable to enlarge change in the magnetic flux generated in the first core 11. Consequently, the present configuration may enable to enlarge the induced electromotive force, which is generated in the coil 13. Thus, the detection device 1 is enabled to enhance accuracy of detection of the revolution of the blade 2.

(2) According to the present embodiment, the first core 11 and the second core 12 are integrally formed. The present configuration may enable to reduce a magnetic resistance between the first core 11 and the second core 12. Therefore, the present configuration may enable to enlarge change in the magnetic flux, which is generated by the second core 12 and the first core 11 due to influence of the magnetic field B2, which is caused by the eddy current I in the blade 2.

### Second Embodiment

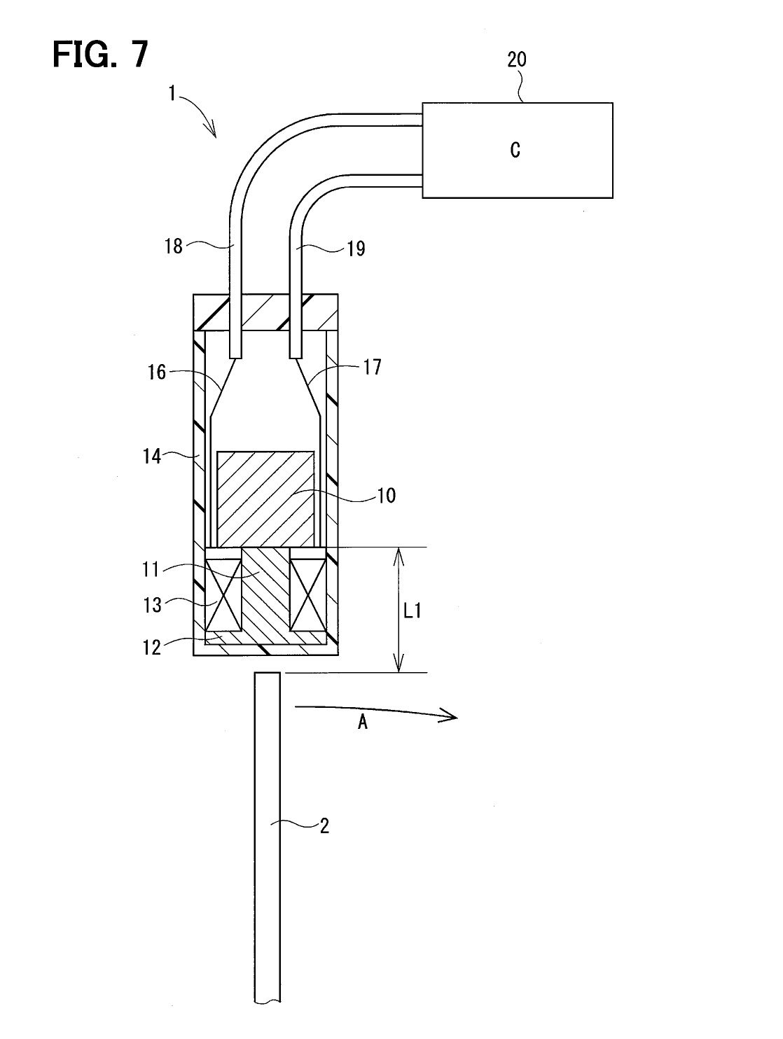

FIG. 7 shows the detection device 1 according to a second embodiment of the present disclosure. As follows, the components substantially equivalent to those in the first embodiment will be denoted by the same reference numerals, and description thereof will be omitted. The detection device 1 according to the second embodiment does not include the bobbin 15 described in the first embodiment. Therefore, the coil 13 is directly wound around the first core 11. Accordingly, in the second embodiment, the distance L1 between the magnet 10 and the blade 2 becomes smaller than that of the first embodiment. The present configuration according to the second embodiment may enable to enhance strength of the magnetic field of the magnet 10 working on the blade 2. In addition, the present configuration may enable to enlarge the range of the magnetic field. Therefore, the present configuration may enable to enhance the eddy current generated in the blade 2, thereby to enhance the magnetic field caused by the eddy current. Thus, the present configuration may enable to enlarge change in the magnetic flux generated by the second core 12 and the first core 11. The present configuration according to the second embodiment may enable to enhance the induced electromotive force generated in the coil 13 thereby to enhance the detection accuracy of the detection device 1.

### Third Embodiment

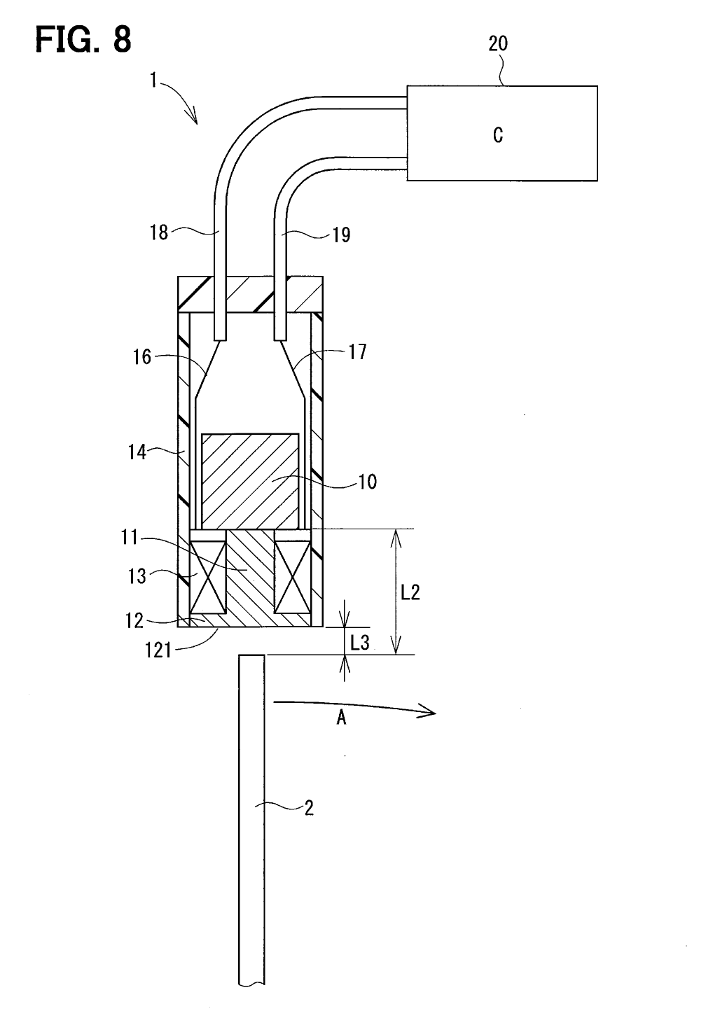

FIG. 8 shows the detection device 1 according to a third embodiment of the present disclosure. The detection device 1 according to the third embodiment has the case 14 having an opening on the blade side. The second core 12 has an end surface 121 on the blade side. The end surface 121 is exposed through the opening of the case 14 to the blade side. Accordingly, in the third embodiment, the distance L2 between the magnet 10 and the blade 2 becomes smaller than those of the first and second embodiments. Accordingly, in the third embodiment, the distance L3 between the second core 12 and the blade 2 becomes smaller than those of the first and second embodiments. The present configuration according to the third embodiment may enable to enhance strength of the magnetic field of the magnet 10 working on the blade 2 and may enable to enlarge the range of the magnetic field. In addition, the present configuration may enable to enlarge the influence of the magnetic field, which is caused by the eddy current generated in the blade 2 and exerted on the second core 12. Therefore, the present configuration may enable to enhance the eddy current generated in the blade 2, thereby to enhance the magnetic field caused by the eddy current. Thus, the present configuration may enable to enlarge change in the magnetic flux generated by the second core 12 and the first core 11. The present configuration according to the third embodiment may enable to enhance the induced electromotive force generated in the coil 13 thereby to enhance the detection accuracy of the detection device 1.

### Fourth Embodiment

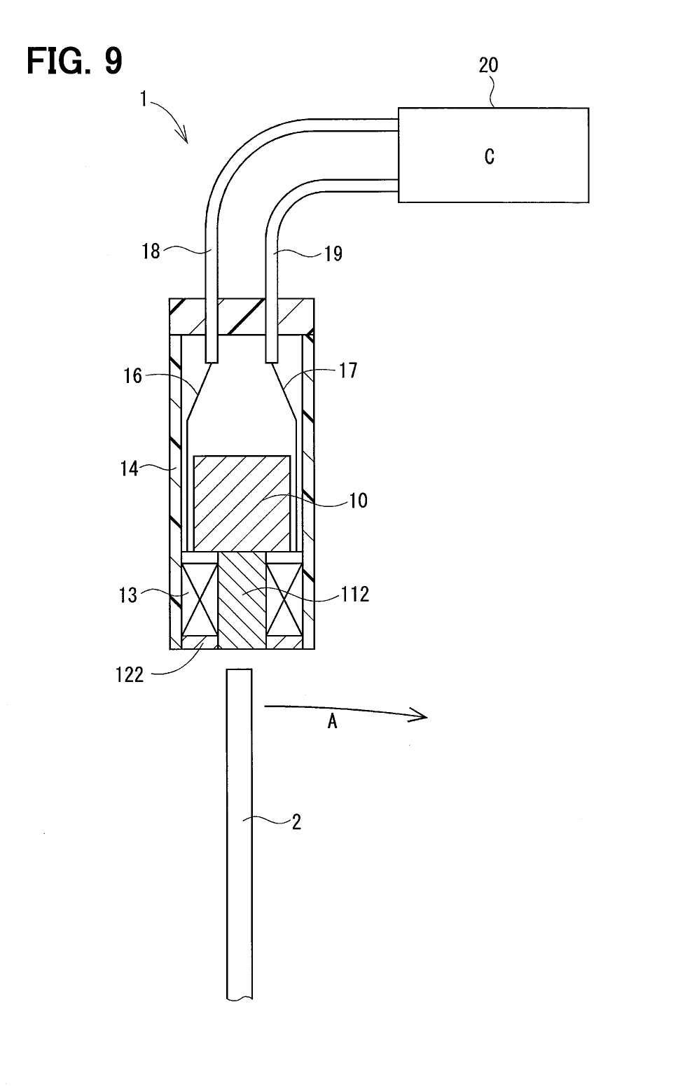

FIG. 9 shows the detection device 1 according to a fourth embodiment of the present disclosure. According to the fourth embodiment, a first core 112, which is in a column shape, and a second core 122, which is in an annular shape, are separate components. The first core 112 and the second core 122 are affixed together by, for example, press-fitting or welding. The present configuration according to the fourth embodiment may enable to facilitate manufacturing of the first core 112 and the second core 122. Therefore, the present configuration may enable to reduce a manufacturing cost for the detection device 1.

### Fifth Embodiment

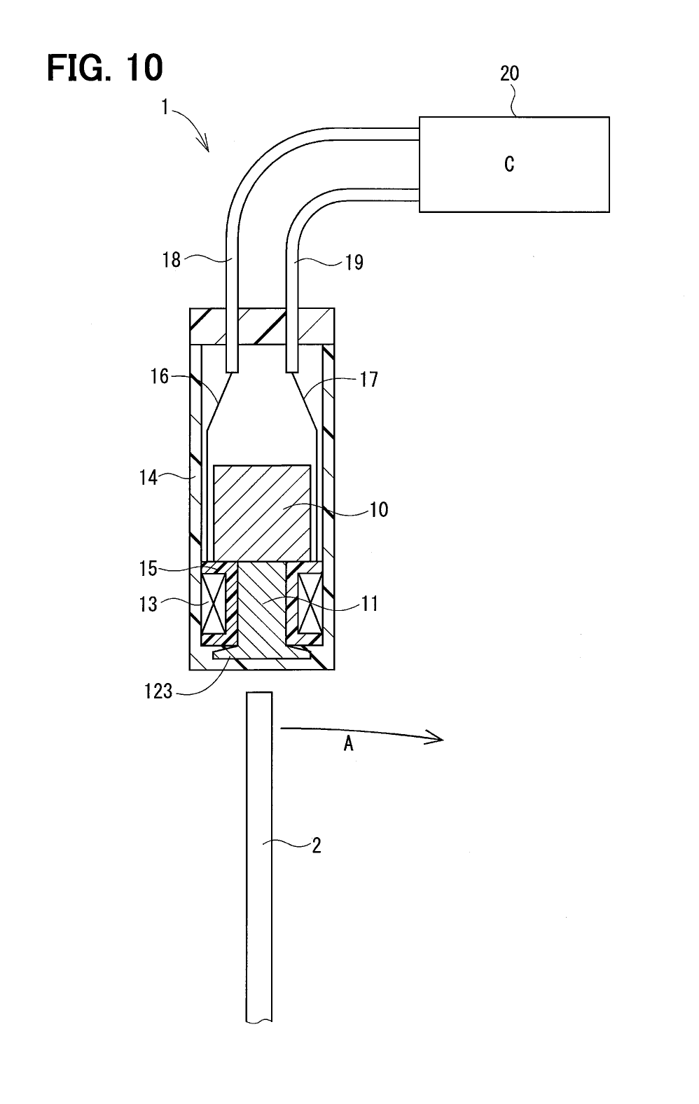

FIG. 10 shows the detection device 1 according to a fifth embodiment of the present disclosure. According to the fifth embodiment, a second core 123 is in a tapered shape. Specifically, the outer diameter of the second core 123 on the counter-blade side is less than the outer diameter of the second core 123 on the blade side. The present configuration according to the fifth embodiment may enable to manufacture the first core 11 and the second core 123 by forging thereby to facilitate manufacturing of the first core 11 and the second core 123. More specifically, a core material, which is in a column shape, is prepared. Subsequently, one end surface of the core material in the axial direction is made in contact with a flat surface of a jig (not shown). Further, force is applied onto the other end surface of the core material in the axial direction toward the jig. In this way, the end surface of the core material on the side of the jig is deformed into a tapered shape. The outer diameter of the deformed core material on the counter-side of the jig is smaller than the outer diameter of the deformed core material on the side of the jig. That is, the second core 123 has a first outer diameter on a side of the jig, the second core 123 has a second outer diameter on an opposite side from the jig, and the second outer diameter (counter-side) is smaller than the first outer diameter. The portion of the second core 123, which has the second diameter, is on the opposite side of the second core 123 from the portion of the second core 123, which has the first diameter. The tapered portion may be equivalent to the second core 123. Thus, the present configuration according to the fifth embodiment may enable to manufacture the first core 11 and the second core 123 by forging thereby to facilitate manufacturing of the first core 11 and the second core 123.

### Other Embodiment

The above-described embodiment has exemplified the detection device configured to detect the revolution of the blade. According to another embodiment, the detection device may be configured to detect movement of various detected objects formed of a nonmagnetic and conductive material.

According to the present disclosure, the detection device is configured to detect movement of the detected object, which is formed of a nonmagnetic and conductive material. The detection device includes the first core and the second core. The first core is located on the detected object side of the magnet. That is, the first core is located on the side of the magnet, the side of the magnet being closer to the detected object. The first core is wound with the coil. The second core is connected with the detected object side of the first core. That is, the second core is connected to the side of the first core, the side of the first core being closer to the detected object. The outer diameter of the second core is greater than the outer diameter of the first core.

The present configuration may enable the second core to enlarge the range of the magnetic field, which is generated by the magnet and exerted on the detected object. Furthermore, the magnetic field, which is caused by the eddy current generated in the detected object, may enable the second core to exert a large influence on the first core. Therefore, the present configuration may enable to enlarge change in the magnetic flux generated in the first core. Consequently, the present configuration enables to enlarge the induced electromotive force, which is generated in the coil. Thus, the detection device is enabled to enhance accuracy of detection of movement of the detected object.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A detection device configured to detect a movement of a detected object, which is formed of a nonmagnetic and conductive material, the detection device comprising:
a magnet configured to generate a magnetic field around a position where the detected object passes;
a first core being a magnetic object and equipped to a detected object side of the magnet;
a coil wound around a radially outside of the first core; and
a second core being a magnetic object and connected to a detected object side of the first core, wherein
the second core is greater than an outer diameter of the first core.

2. The detection device according to claim 1, wherein the coil is wound directly around the radially outside of the first core without interposing a bobbin, which is formed of an insulative material, between the coil and the first core.

3. The detection device according to claim 1, further comprising:
a case accommodating the coil, wherein
the second core is exposed from the case to the detected object.

4. The detection device according to claim 1, wherein the first core and the second core are integrally formed with each other.

5. The detection device according to claim 1, wherein the first core and the second core are separate components.

6. The detection device according to claim 1, wherein
the second core is in a tapered shape,
the second core has a first outer diameter on a side of the detected object,
the second core has a second outer diameter on an opposite side from the detected object, and
the second outer diameter is smaller than the first outer diameter.

7. The detection device according to claim 1, wherein the detected object is a turbine blade in a thin-plate shape.
